(19) United States
(12) Patent Application Publication
(10) Pub. No.: US 2026/0149285 A1
(43) Pub. Date: May 28, 2026

(54) DISTRIBUTED GENERATION UNIT, ELECTRICAL MICROGRID SYSTEM, AND METHOD OF CURRENT-SHARING CONTROL IN ELECTRICAL MICROGRID SYSTEM

(71) Applicants: LITE-ON SINGAPORE PTE. LTD., Singapore (SG); Nanyang Technological University, Singapore (SG)

(72) Inventors: Fei DENG, Singapore (SG); Yi TANG, Singapore (SG); Lei ZHANG, Singapore (SG); Ziheng XIAO, Singapore (SG); Zhigang YAO, Singapore (SG); Jing YANG, Singapore (SG); Shih-Ming CHEN, TAIPEI CITY (TW); Yi Chyn Cassandra WONG, Singapore (SG)

(21) Appl. No.: 19/093,586

(22) Filed: Mar. 28, 2025

Related U.S. Application Data
(60) Provisional application No. 63/724,500, filed on Nov. 25, 2024.

(51) Int. Cl. H02J 3/38; H02J 3/46

(52) U.S. Cl. CPC H02J 3/381; H02J 3/46; H02J 2103/30

(57) ABSTRACT

A distributed generation unit (DGU) is provided. The DGU includes a meter and a processor. The meter generates a per-unit current based on the rated power value of the DGU. The processor is coupled between a control area network (CAN) bus and the circuit block. The processor causes the DGU to identify a first electrical signal at an initial time and perform a master selection process. The master selection process includes determining the delay time based on the per-unit current and the maximum per-unit current, identifying the per-unit current as the maximum per-unit current when the delay time has elapsed since the initial time, and broadcasting the maximum per-unit current and a second electrical signal through the CAN bus. The processor is further configured to perform a droop coefficient regulation process to maintain the current state of the DGU after the second electrical signal is broadcast.

### CROSS REFERENCE TO RELATED APPLICATIONS

This application claims the benefit of U.S. Provisional Application No. 63/724,500, filed Nov. 25, 2024, the entirety of which is incorporated by reference herein.

### BACKGROUND OF THE INVENTION

### Field of the Invention

The present invention relates to current-sharing control, and, in particular, to current-sharing control between multiple distributed generation units (DGUs) with less communication load.

### Description of the Related Art

Power management and current/voltage regulation between parallel distributed generation units (DGUs) are essential to ensure normal and effective system operation. In a system that includes many DGUs, the power rating and the output power of each DGU may be mismatched. Communications between these DGUs may be utilized to adjust the output power of each DGU. However, when the system includes many DGUs, the amount of communication data may be considerable, accounting for a large proportion of the control and communication resources of the system.

### BRIEF SUMMARY OF THE INVENTION

An embodiment of the present invention provides a distributed generation unit (DGU), comprising a meter and a processor. The meter is configured to generate a per-unit current of a circuit block based on a rated power value of the DGU. The processor is coupled between a control area network (CAN) bus and the circuit block, wherein the processor is configured to cause the DGU to identify a first electrical signal that indicates a master selection start event at an initial time and perform a master selection process.

The master selection process comprises determining a delay time based on the per-unit current and a maximum per-unit current. The master selection process further comprises identifying the per-unit current as the maximum per-unit current when the delay time has elapsed since the initial time. The master selection process further comprises broadcasting the maximum per-unit current as well as a second electrical signal that indicates a master selection end event through the CAN bus after the per-unit current is identified as the maximum per-unit current. The processor performs a droop coefficient regulation process to maintain the current state of the DGU after the second electrical signal is broadcast.

An embodiment of the present invention provides a distributed generation unit (DGU), comprising a meter and a processor. The meter is configured to generate a per-unit current of a circuit block based on a rated power value of the DGU. The processor is coupled between a control area network (CAN) bus and the circuit block, wherein the processor is configured to cause the DGU to identify a first electrical signal that indicates a master selection start event at an initial time and perform a master selection process.

The master selection process comprises determining a delay time based on the per-unit current and a maximum per-unit current. The master selection process further comprises receiving a second electrical signal that indicates a master selection end event through the CAN bus before the delay time has elapsed since the initial time. The master selection process further comprises suspending the master selection process in response to the second electrical signal. The processor performs a droop coefficient regulation process to modify the present power value of the DGU in response to the second electrical signal.

An embodiment of the present invention provides an electrical microgrid system, comprising a CAN bus, a plurality of meters, and a plurality of processors. The meters are configured to generate a first per-unit current based on a first rated power value of a first DGU, and configured to generate a second per-unit current based on a second rated power of a second DGU. The processors are coupled to the CAN bus and are configured to identify a first electrical signal that indicates a master selection start event, determine a first delay time based on the first per-unit current and a maximum per-unit current, and determine a second delay time based on the first per-unit current and the maximum per-unit current.

The processors are further configured to identify the first per-unit current as the maximum per-unit current in response to the first delay time being less than the second delay time; broadcast, from the first DGU through the CAN bus, the master per-unit current and a second electrical signal that indicates a master selection end event; receive, at the second DGU through the CAN bus, the second electrical signal and the maximum per-unit current; and cause the first DGU to perform a droop coefficient regulation process to maintain a first present power value of the first DGU, and cause the second DGU to perform the droop coefficient regulation process to modify a second present power value after the second electrical signal is broadcast.

An embodiment of the present invention provides a method of current-sharing control in an electrical microgrid system. The method comprises generating a first per-unit current based on a first rated power value of a first distributed generation unit (DGU) and a second per-unit current based on a second rated power value of a second DGU. The method further comprises identifying a first electrical signal that indicates a master selection start event at an initial time, determining a first delay time by adding a first delay constant to a multiple of a difference between the first per-unit current and a maximum per-unit current, and determining a second delay time by adding a second delay constant to a multiple of a difference between the second per-unit current and the maximum per-unit current after the first electrical signal is identified.

The method further comprises identifying the first per-unit current as the maximum per-unit current in response to the first delay time elapsing earlier than the second delay time; broadcasting the maximum per-unit current and a second electrical signal that indicates a master selection end event when the first delay time elapses after the initial time; and generating a third electrical signal with a first level (Fstg=2) to maintain a first present power value of the first DGU and to modify a second present power value of the second DGU in response to the second electrical signal.

### BRIEF DESCRIPTION OF THE DRAWINGS

The present invention can be more fully understood by reading the subsequent detailed description and examples with references made to the accompanying drawings, wherein:

FIG. 1 shows an electrical microgrid system with two distributed generation units (DGUs) according to an embodiment of the present disclosure.

FIG. 2 shows an example of a master DGU according to an embodiment of the present disclosure.

FIG. 3 shows an example of a slave DGU according to an embodiment of the present disclosure.

FIGS. 4A to 4D show a method of current-sharing control in an electrical microgrid system with less communication according to an embodiment of the present disclosure.

FIG. 5A shows a diagram of an electrical signal indicating a master selection start event in different DGUs according to an embodiment of the present disclosure.

FIG. 5B shows a diagram of an electrical signal indicating a master selection end event in different DGUs according to an embodiment of the present disclosure.

FIG. 5C shows a diagram of the electrical signals indicating the master selection start event and the master selection end event in a DGU according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In recent decades, power systems are struggling to satisfy the growing electrical power requirement. Therefore, microgrids are proposed as a solution. In DC microgrids, various distributed generation units (DGU), e.g., photovoltaic panels and batteries, are integrated within. To meet the desired performance (e.g., current sharing), the output power of each DGU should be proportional to its power rating. However, due to the distribution of the DC microgrids, the output power and the power ratings of the DGUs are often mismatched.

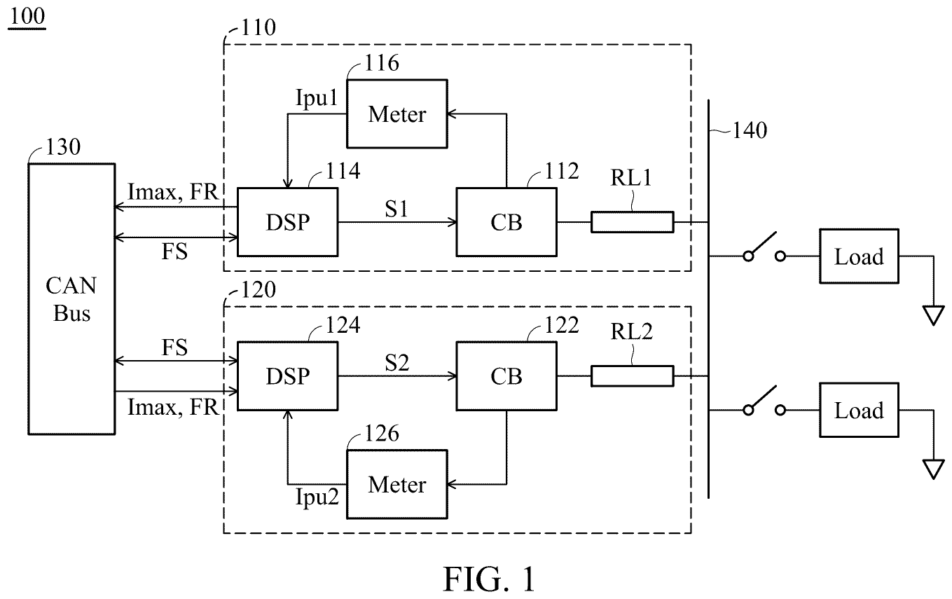

FIG. 1 shows an electrical microgrid system 100 with two distributed generation units (DGUs) 110 and 120 according to an embodiment of the present disclosure. DGU 110 has a line impedance RL1 and includes a circuit block (CB) 112, a digital signal processor (DGU) 114, and a meter 116. DGU 120 has a line impedance RL2 and includes a circuit block 122, a DSP 124, and a meter 126. DSPs 114 and 124 can be any processor or processing unit that controls the DGUs 110 and 120, respectively. Additionally, the electrical microgrid system 100 includes a control area network (CAN) bus 130, a DC bus 140, and a plurality of loads coupled between the DC bus 140 and the ground. The CAN bus 130 is coupled to the DGUs 110 and 120 to provide communication gateways for the DGUs 110 and 120.

As mentioned above, current sharing is one of the essential targets to ensure normal and effective system operations, and the desired current sharing performance of a DGU is that the output power is proportional to the power rating. Referring to FIG. 1, DGU 110 has line impedance RL1, and DGU 120 has line impedance RL2. Therefore, the ratio of the output power (i.e., current that flows through the loads) of DGU 110 to DGU 120 is roughly RL2:RL1, which is associated with the line impedances but not the power ratings. To adjust the current sharing performance, virtual impedance is introduced.

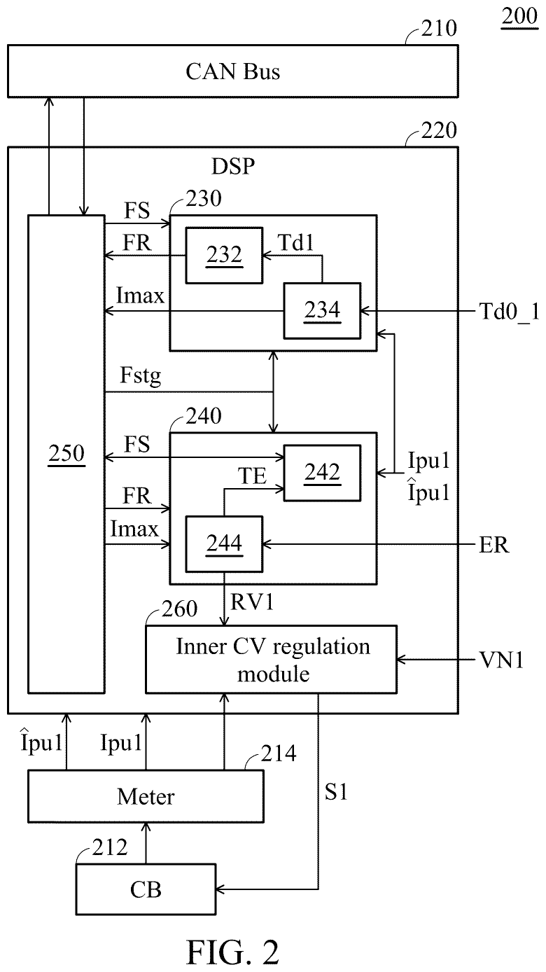

Assuming that virtual impedances RV1 and RV2 (see FIG. 2) are introduced to the DGUs 110 and 120, respectively, in which the virtual impedances RV1 and RV2 are fixed virtual impedances. To achieve the desired current-sharing performance, the fixed virtual impedances RV1 and RV2 may have impedance values proportional to the power ratings of DGUs 110 and 120. However, to reduce or eliminate the affection of line impedances on the output power of DGUs 110 and 120, fixed virtual impedances RV1 and RV2 must be much greater than the line impedances RL1 and RL2. This will lead to an undesired voltage drop.

As a result, the present disclosure introduces adaptive virtual impedance instead of fixed virtual impedance. Therefore, the ratio of the output power of DGUs 110 and 120 can be rewritten as (RL2+RV2):(RL1+RV1), in which the virtual impedances RV1 and RV2 are changeable. By selecting suitable values for virtual impedances RV1 and RV2, the output power of DGUs 110 and 120 may be proportional to their power rating, and the voltage drop caused by large impedance can be reduced or eliminated. However, to adaptively modify the values of the virtual impedances RV1 and RV2, communication between DGUs 110 and 120 (or more parallel DGUs), or between DGUs and the central controller (not shown) of the electrical microgrid system 100 is required. Therefore, the present disclosure provides a master selection (or differential-delay-based) strategy to limit the amount of the required communication data.

Referring to FIG. 1, DSP 112 or DSP 122 (or another DSP in a third DGU of the electrical microgrid system 100) broadcasts or receives a first electrical signal FS to trigger a master selection process (i.e., function as a master selection start event) to select a master DGU based on delay times of DGU 110 and 120. Specifically, when the master selection process is triggered, the meters 116 and 126 generate per-unit currents Ipu1 and Ipu2 according to the rated power of the circuit blocks 114 and 124, respectively. Then, DSPs 112 and 122 receive the per-unit currents Ipu1 and Ipu2 to calculate delay times Td1 and Td2 of the DGUs 110 and 120 (see FIG. 2). If the delay time Td1 is less than the delay time Td2, DGU 110 is selected as the master DGU of the electrical microgrid system 100, while DGU 120 is identified as a slave DGU. In other embodiments, the electrical microgrid system 100 may include more than two DGUs, but there will still only be one master DGU and the rest will be slave DGUs.

After the DGU 110 is selected as the master DGU, DSP 112 of the DGU 110 broadcasts the per-unit current Ipu1 as a maximum per-unit current Imax of the electrical microgrid system 100 and transmits the maximum per-unit current Imax to the DGU 120 through the CAN bus 130. Additionally, DSP 112 broadcasts a second electrical signal FR through the CAN bus 130 to trigger a droop coefficient regulation process to modify the output power of DGU 120. The second electrical signal FR may also stop the master selection process (i.e., function as a master selection end event) since the master DGU of the electrical microgrid system 100 (i.e., DGU 110) is selected.

Next, the DGU 120 performs the droop coefficient regulation process to modify its output power by outputting a control signal S2 from the DSP 122 to the circuit block 124. Specifically, the droop coefficient regulation process modifies the virtual impedance RV2 of the DGU 120 to adjust the output power of DGU 120 and improve the current sharing performance between DGUs 110 and 120. It should be noted that though DGU 110 may also identify the second electrical signal FR broadcast by itself, a control signal S1 output by the DSP 112 will not modify the virtual impedance RV1 of DGU 110. Instead, the control signal S1 will maintain the current state of the DGU 110 until the first electrical signal FS is identified (e.g., received from other DGUs or broadcast by DGU 110 itself). At that time, the next master selection process will be performed, and a new master DGU will be selected. The details of the master selection process and the droop coefficient regulation process will be described in the following paragraphs along with FIGS. 2, 3, and 4A-4D.

When there is a large number of DGUs in the electrical microgrid system, the amount of communication data is considerable and will account for a large proportion of the communication resources. By introducing the master selection process, only the master DGU transmits data (e.g., the maximum per-unit current Imax) to all of the slave DGUs (e.g., DGU 120), while each of the slave DGUs will not transmit any data to other DGUs in the electrical microgrid system. As a result, a great amount of communication resource is saved.

To further reduce the amount of communication data, the first electrical signal FS and the second electrical signal FR function as parts of the event-triggered mechanism for the master selection process and the droop coefficient regulation process. These processes will be performed only when the corresponding signals are broadcast, which also reduces the times of performing the master selection process and the droop coefficient regulation process compared with conventional periodic-triggered mechanism.

FIG. 2 shows an example of a master DGU 200 according to an embodiment of the present disclosure. Similar to the DGU 110 of FIG. 1, the master DGU 200 is coupled to a CAN bus 210 and includes a circuit block 212, a meter 214, and a DSP 220. The DSP 220 includes a master selection module 230 for the master selection process, a droop coefficient regulation module 240 for the droop coefficient regulation process, a communication bus 250, and an inner current and voltage (CV) regulation module 260 to generate the control signal S1. The communication bus 250 communicates with the other communication buses in other DSP through the CAN bus 210. The meter 212 generates the per-unit current Ipu1 based on the rated power of the master DGU 200. Additionally, the meter 212 further generates an initial per-unit current Îpu1 in response to the second electrical signal FR.

The master selection module 220 of the master DGU 200 initiates the master selection process when it identifies the first electrical signal FS at an initial time, either received from other DGUs through the CAN bus 210 and the communication bus 250, or broadcast by the droop coefficient regulation module 240 of the master DGU 200 through the communication bus 250. After identifying the first electrical signal FS, the DSP 220 generates a third electrical signal Fstg that has a first level (e.g., representing a value of 1) to trigger the delay time generator 232 to generate the first delay time Td1 based on a first delay constant Td0_1, the per-unit current Ipu1, and the maximum per-unit current Imax. The maximum per-unit current Imax may be the maximum per-unit current from the previous master selection process. Specifically, the first delay time Td1 may be generated by a delay time generator 232 based the following equation:

$$Td 1 = {k}_{d} \times ( I max - Ipu 1 ) + Td0\_ 1 \qquad ( 1 )$$

Where k_{d} is a preset gain factor, and the first delay constant Td0_1 is a preset constant that ensures a suitable time gap between each master selection process to prevent the next master selection process from performing before the following operations are finished. Additionally, since the first delay constant Td0_1 is preset, it may also indicate the priority of the DGUs in the same microgrid. For example, DGUs 110 and 120 of FIG. 1 may have different delay constants. When the delay constant of DGU 110 is much larger than the delay constant of DGU 120, DGU 110 will have a bigger chance to be selected as the master DGU, thus having a higher priority than the DGU 120 in the master selection process.

Then, the delay time generator 232 transmits the first delay time Td1 to a timer 234 to determine whether the first delay time Td1 has elapsed since the initial time (i.e., the timestamp that the first electrical signal FS is identified). Assuming that the master DGU 200 has the largest per-unit current among all the DGUs in the microgrid. As a result, regarding equation (1), the master DGU 200 will have the shortest delay time among all the DGUs, and thus the first delay time Td1 will elapse before any other DGUs in the same microgrid. In response to the first delay time Td1 elapsing since the initial time, the DSP 220 broadcasts the second electrical signal FR to other DGUs through the communication bus 250 and the CAN bus 210.

Since the master DGU 200 has the shortest delay time, the other DGUs will receive the second electrical signal FR when they are all still counting their delay times, i.e., the master selection process in the other DGUs is not finished. Therefore, the second electrical signal FR indicates the master selection end event and may cause the other DGUs to suspend the master selection process. After the second electrical signal FR is broadcast, the DSP 220 generates the third electrical signal Fstg that has a second level (e.g., representing a value of 2) to trigger the droop coefficient regulation module 240 to perform the droop coefficient regulation process.

In response to the second electrical signal FR, the meter 214 generates the initial per-unit current Îpu1 to modify the virtual impedance RV1 using a regulator 344. The virtual impedance RV1 is adjusted by a change rate e1(t) that is based on the maximum per-unit current Imax and the initial per-unit current Îpu1. Specifically, the relationship between the virtual impedance RV1 and the change rate e1(t) can be written as:

$$\frac{dRV 1}{dt} = {k}_{c} \times e 1 ( t ) \qquad ( 2 a )$$

$$e 1 ( t ) = \hat{I} pu 1 - I max \qquad ( 2 b )$$

Where k_{c} is a gain coefficient.

Since the initial per-unit current Îpu1 is defined as the per-unit current Ipu1 at a timestamp when the second electrical signal FR is identified, and the maximum per-unit current Imax is the per-unit current Ipu1 at a timestamp when the first electrical signal FS is identified, the change rate e1(t) will not change until the current droop coefficient regulation process is ended. That is, the virtual impedance RV1 is adjusted by a constant change rate. However, in this embodiment, the master DGU 200 is selected as the master DGU of a microgrid, which indicates that the maximum per-unit current Imax is the per-unit current Ipu1 of the master DGU 200 itself. Therefore, the initial per-unit current Îpu1 is equal to the maximum per-unit current Imax, causing the change rate e1(t) to become zero. In other words, the DGU that is selected as the master DGU will not adjust its virtual impedance and will maintain its current state (e.g., maintain its virtual impedance).

As a result, referring to FIG. 2, the control signal S1 generated by the inner CV regulation module 260 will not adjust the current state of the circuit block 214. Instead, the control signal S1 will maintain the current state (e.g., maintain the output voltage/power) of the circuit block 214. Therefore, it can also be regarded as the master DGU 200 does not need to perform the droop coefficient regulation.

Each droop coefficient regulation process may take some time to finish, and the present per-unit current Ipu1 may not be the same as the initial per-unit current Îpu1. Therefore, a current increment γ1 is introduced, which can be defined as:

$$γ1 = \hat{I} pu 1 - Ipu 1 \qquad ( 3 )$$

Next, to determine whether the next master selection process should be triggered, a trigger function f_{tc} is defined as:

$${F}_{tc} = {‖ γ1 ‖}^{2} - κ {‖ I max ‖}^{2} \qquad ( 4 )$$

Where κ is a gain coefficient.

When the relationship between the current increment γ1 and the maximum per-unit current Imax meets a first criterion, which is f_{tc}≥0, the master DGU 200 is no longer operating at the desired current sharing performance. As a result, regulator 344 outputs a trigger enable signal TE to trigger controller 322. The trigger controller 322 then generates the first electrical signal FS and broadcasts it through the communication bus 250 and the CAN bus 210, causing the rest of the DGUs to suspend their droop coefficient regulation process and trigger the next master selection process. In other embodiments, the first DGU in a microgrid to meet the first criterion may not be the master DGU but one of the slave DGUs. That is, the first electrical signal FS may not be broadcast by the master DGU 200.

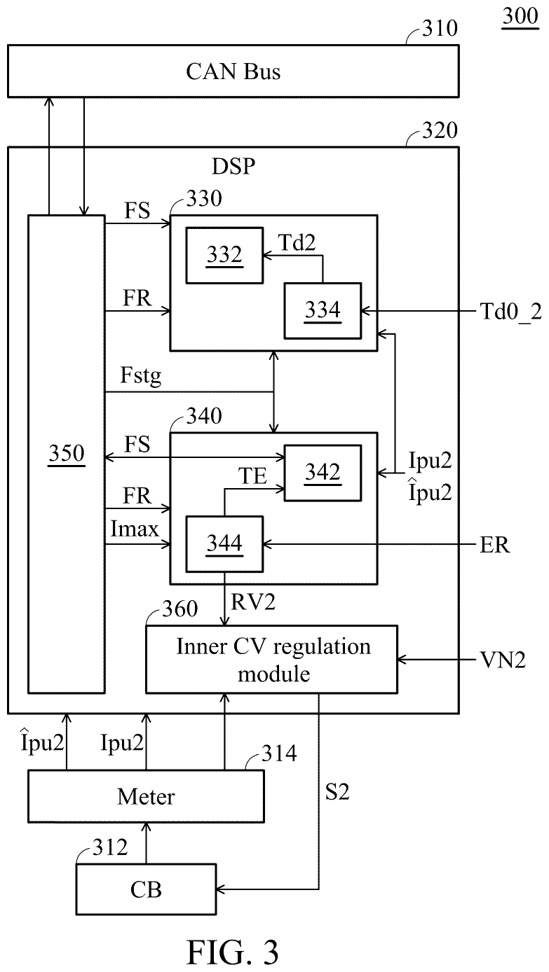

FIG. 3 shows an example of a slave DGU 300 according to an embodiment of the present disclosure. Similar to the DGU 120 of FIG. 1, the slave DGU 300 is coupled to a CAN bus 310 and includes a circuit block 312, a meter 314, and a DSP 320. The DSP 320 includes a master selection module 330, a droop coefficient regulation module 340, a communication bus 350, and an inner CV regulation module 360 to generate the control signal S2. The communication bus 350 communicates with the other communication buses in other DSPs through the CAN bus 310. The meter 312 generates the per-unit current Ipu2 based on the rated power of the slave DGU 300. Additionally, the meter 312 further generates an initial per-unit current Îpu2 in response to the second electrical signal FR.

Similar to DGU 120, the slave DGU 300 generates the per-unit current Ipu2 and performs the master selection process after the first electrical signal FS and the third electrical signal Fstg having the first level (e.g., representing a value of 1) are identified. Then, a delay time generator 334 generates a second delay time Td2 based on the following relationship:

$$Td 2 = {k}_{d} \times ( I max - Ipu 2 ) + Td0\_ 2 \qquad ( 5 )$$

Where Imax is the maximum per-unit current of the previous master selection process, and Td0_2 is a second delay constant that may be the same as or different from the first delay constant Td0_1.

Assuming that the master DGU 200 and the slave DGU 300 are in the same microgrid and that the second delay time Td2 of the slave DGU 300 is greater than the first delay time Td1. Therefore, while timer 332 of the slave DGU 300 is still counting the second delay time Td2, the timer 232 of the master DGU 200 may finish counting the first delay time Td1 and broadcast the second electrical signal FR to indicate the master selection end event. As a result, the slave DGU 300 suspends its master selection process (i.e., stops counting the second delay time Td2), triggers the droop coefficient regulation process by the third electrical signal Fstg with the second level (e.g., representing a value of 2), and generates the initial per-unit current Îpu2 at a timestamp which the second electrical signal FR is broadcast.

Since the initial per-unit current Îpu2 is different from the maximum per-unit current Imax (which is the per-unit current Ipu1 of the master DGU 200), the virtual impedance RV2 of the slave DGU 300 is adjusted by a change rate e2(t) through a regulator 344 according to the following equations (6a) and (6b):

$$\frac{dRV 2}{dt} = {k}_{c} \times e 2 ( t ) \qquad ( 6 a )$$

$$e 2 ( t ) = \hat{I} pu 2 - I max \qquad ( 6 b )$$

Where k_{c} is the gain coefficient. As a result, the control signal S2 generated by the inner CV regulation module 360 adjusts the output voltage/power of the circuit block 314 based on the variation of the virtual impedance RV2.

Each droop coefficient regulation process may take some time to finish, and the present per-unit current Ipu2 may not be the same as the initial per-unit current Îpu2. Therefore, a current increment γ2 is introduced, which can be defined as:

$$γ2 = \hat{I} pu 2 - Ipu 2 \qquad ( 7 )$$

Next, referring to equation (4), the trigger function f_{tc} can be rewritten as:

$${F}_{tc} = {‖ γ2 ‖}^{2} - κ {‖ I max ‖}^{2} \qquad ( 8 )$$

Where κ is the gain coefficient.

When the relationship between the current increment γ2 and the maximum per-unit current Imax meets the first criterion (i.e., f_{tc}≥0), the slave DGU 300 is no longer operating at the desired current sharing performance. As a result, regulator 344 outputs the trigger enable signal TE to trigger controller 322. The trigger controller 322 then generates the first electrical signal FS and broadcasts it through the communication bus 350 and the CAN bus 310, causing the rest of the DGUs to suspend their droop coefficient regulation process and trigger the next master selection process. In other embodiments, the first DGU in a microgrid to meet the first criterion may be one of the DGUs other than the slave DGU 300. As a result, the slave DGU 300 suspends its droop coefficient regulation process upon receiving the first electrical signal FS.

The droop coefficient regulation process is performed to accomplish the desired current sharing performance, which indicates that by adjusting the virtual impedances of each slave DGU, the difference between the present per-unit current Ipu2 and the initial per-unit current Îpu2 will become smaller and generates a smaller current increment γ2. Since the value of the maximum per-unit current Imax is constant throughout the droop coefficient regulation process, it can be inferred that the value of the trigger function f_{tc} will have a higher chance of being less than zero in response to the current increment γ2 being smaller. At this time, a current error |δ| is introduced, which can be defined as:

$$\vert δ \vert = \vert Ipu 2 - I max \vert \qquad ( 9 )$$

The current error |δ| may be utilized to suspend the current droop coefficient regulation process without the first electrical signal FS and maintain the current state of the slave DGU 300. Specifically, according to equation (8), the droop coefficient regulation process will continue when the trigger function f_{tc} is less than zero. However, after many times of adjustments to the virtual impedance RV2, the fact that the trigger function f_{tc} is less than zero may indicate that the slave DGU 300 has accomplished the desired current sharing performance, and the droop coefficient regulation process can hardly reduce the current error of the slave DGU 300.

To further save communication resources, a second criterion is defined as |δ|≤ξ, where ξ is a preset error range. When the current error |δ| meets the second criterion (i.e., the current error |δ| is within the preset error range), the droop coefficient regulation process is suspended, and the DSP 320 determines whether the trigger function f_{tc} is less than zero. By repeatedly determining whether the current error |δ| is within the preset error range, and whether the trigger function f_{tc} is less than zero, the slave DGU 300 maintains its current virtual impedance RV2 and its output power without continuously performing the droop coefficient regulation process until the next master selection process is triggered.

Still referring to FIGS. 2 and 3, the inner CV regulation modules 260 and 360 further receive the rated voltages VN1 and VN2 of the master DGU 200 and the slave DGU 300, respectively. After the droop coefficient regulation process, the virtual impedances RV1 and RV2 are generated to maintain or adjust the output voltage/power of the master DGU 200 and the slave DGU 300. That is, the output voltages of the master DGU 200 and the slave DGU 300 (represented by Vout1 and Vout2, respectively) can be represented as:

$$V out 1 = V N 1 - Ipu 1 \times ( RL 1 + R V 1 ) \qquad ( 10 a )$$

$$V out 2 = V N 2 - Ipu 2 \times ( RL 2 + R V 2 ) \qquad ( 10 b )$$

Therefore, by properly adjusting the virtual impedances of the DGUs, the output voltage/power of each DGU may be modified to accomplish the desired current sharing performance.

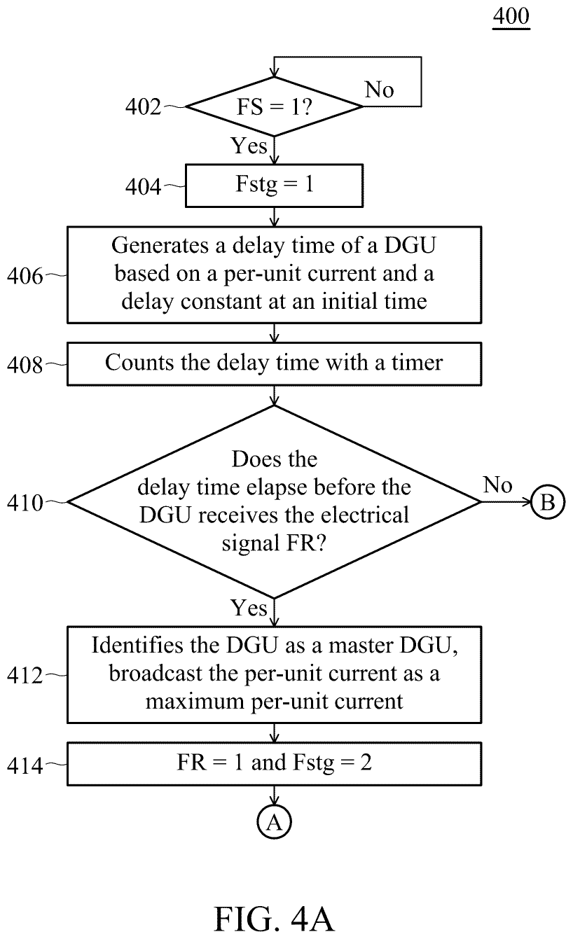

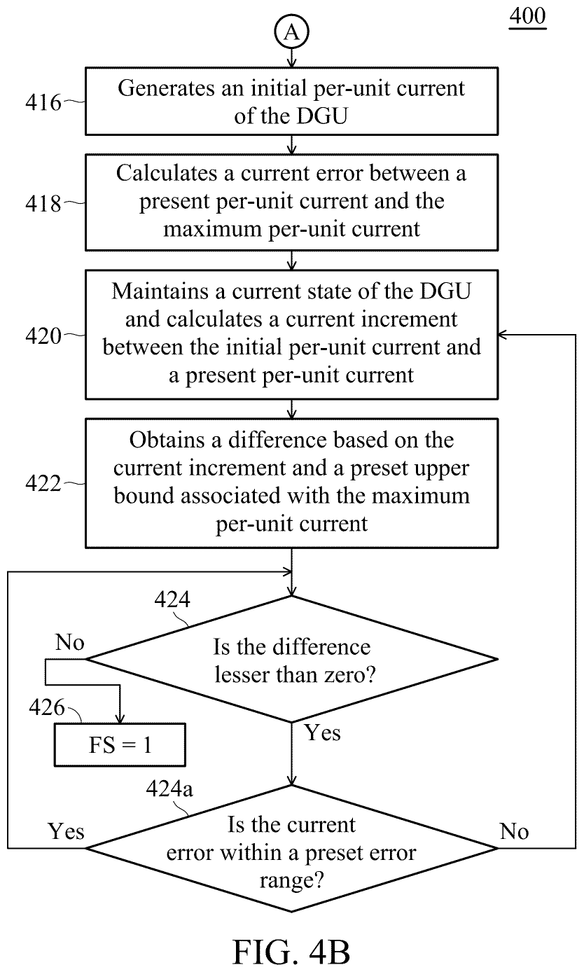

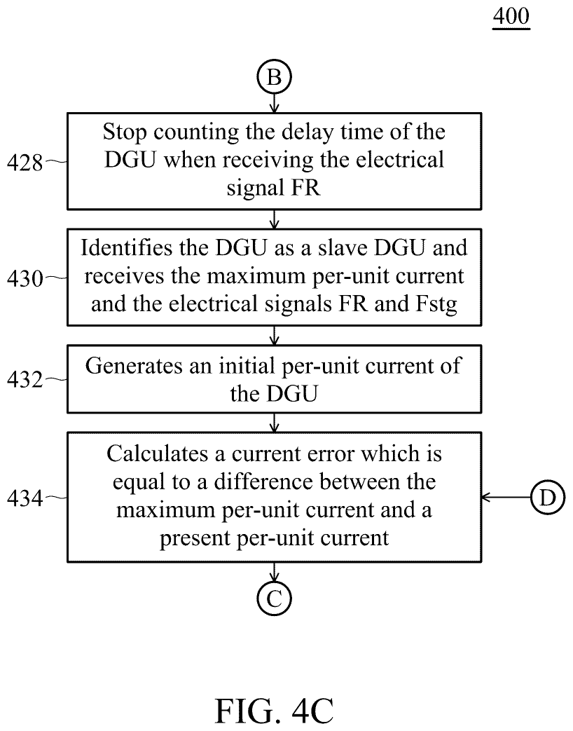

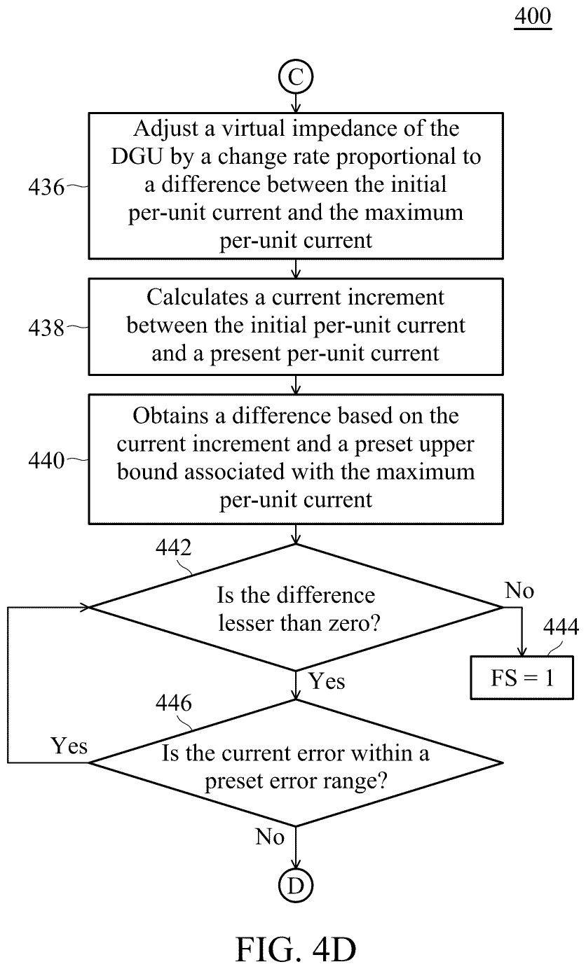

FIGS. 4A to 4D show a method 400 of current-sharing control in an electrical microgrid system with less communication according to an embodiment of the present disclosure. Assuming that there is more than one DGU in an electrical microgrid. At step 402, all of the DGUs in the electrical microgrid determine whether the first electrical signal FS is broadcast. If the first electrical signal FS is not identified, method 400 repeats step 402 until the first electrical signal FS is identified. If the first electrical signal FS is identified, method 400 goes to step 404, where the third electrical signal Fstg is set to a first level (e.g., represents a value of 1). At this time (i.e., an initial time), each DGU starts performing the master selection process, and generates a delay time according to the per-unit current and the delay constant of each DGU, as indicated by equations (1) or (5).

Then, at steps 408 and 410, the timer of each DGU starts counting the delay time and determines whether the delay time elapses before the DGU identifies the second electrical signal FR. If the delay time elapses before the second electrical signal FR is identified, i.e., the DGU has the shortest delay time, method 400 goes to step 412, the DGU is identified as the master DGU, and the per-unit current of this DGU is broadcast as the maximum per-unit current. Next, the master DGU broadcasts the second electrical signal FR and the third electrical signal Fstg with a second level (e.g., representing a value of 2). After the second electrical signal FR is broadcast, method 400 goes to steps 416 and 418 (i.e., starts the droop coefficient regulation process), where the master DGU generates an initial per-unit current (e.g., the per-unit current at the timestamp when the second electrical signal FR is identified) and calculates the current error between the maximum per-unit current and the present (or real-time) per-unit current.

Regarding equations (2a) and (2b), the virtual impedance of the master DGU will not be adjusted since the initial per-unit current of the master DGU will be the same as the maximum per-unit current. Therefore, method 400 enters step 420 to maintain the current state of the master DGU and calculates the current increment equal to the difference between the initial per-unit current and the present per-unit current by equation (3). Then, at step 422, the trigger function f_{tc} is determined by the difference between the current increment squared (i.e., ∥γ1∥²) and a multiple of the maximum per-unit current squared (i.e., κ∥Imax∥²). The master DGU then determines whether the trigger function f_{tc} meets a first criterion (i.e., f_{tc}≥0).

If f_{tc}≥0, the master DGU broadcasts the first electrical signal FS to trigger the next master selection process. If the trigger function f_{tc} is less than 0, the master DGU determines whether the current error is within an error range (step 424a). If the current error is within the error range, the method goes back to step 424 to determine whether the trigger function f_{tc} is less than 0. If the current error exceeds the error range, the method 400 goes back to step 420 and generates a new current increment equal to the difference between the initial per-unit current and the present per-unit current while maintaining the virtual impedance of the master DGU.

Regarding step 410, if the DGU receives the second electrical signal FR before its delay time elapses after the initial time, method 400 goes to step 428, where the master selection process is suspended to stop counting the delay time of the DGU. At step 430, the DGU is identified as a slave DGU. Then, the slave DGU receives the maximum per-unit current from the master DGU and triggers the droop coefficient regulation process in response to the second electrical signal FR and the third electrical signal Fstg having a second level (e.g., representing a value of 2). After the droop coefficient regulation process is triggered, at steps 432 and 434, the slave DGU generates an initial per-unit current at the timestamp when the second electrical signal is received. Additionally, the slave DGU calculates the current error between the present per-unit current and the maximum per-unit current.

Since the maximum per-unit current is different from the initial per-unit current of the slave DGU, at step 436, the virtual impedance of the slave DGU is adjusted at a rate proportional to the difference between the maximum per-unit current and the initial per-unit current of the slave DGU. Then, at steps 438 and 440, the current increment and the trigger function f_{tc} are calculated as indicated by equations (7) and (8). The slave DGU determines whether the trigger function f_{tc} is less than zero in step 442. If f_{tc}≥0, the slave DGU broadcasts the first electrical signal FS to trigger the next master selection process (step 444). If the trigger function f_{tc} is less than 0, the slave DGU determines whether the current error is within an error range (step 446).

If the current error is within the error range, the method goes back to step 442 to determine whether the trigger function f_{tc} is less than 0. If the current error exceeds the error range, method 400 goes back to step 434. At this time, since the virtual impedance has changed (e.g., at a rate proportional to the difference between the maximum per-unit current and the initial per-unit current), the present per-unit current will also change, causing the current error, current increment, and the trigger function f_{tc} to change. The method 400 will continue to adjust the virtual impedance to modify the present per-unit current of the slave DGU until the trigger function f_{tc} meets the first criterion (i.e., f_{tc}≥0) and triggers the next master selection process with the first electrical signal FS, or until the current error is within the error range.

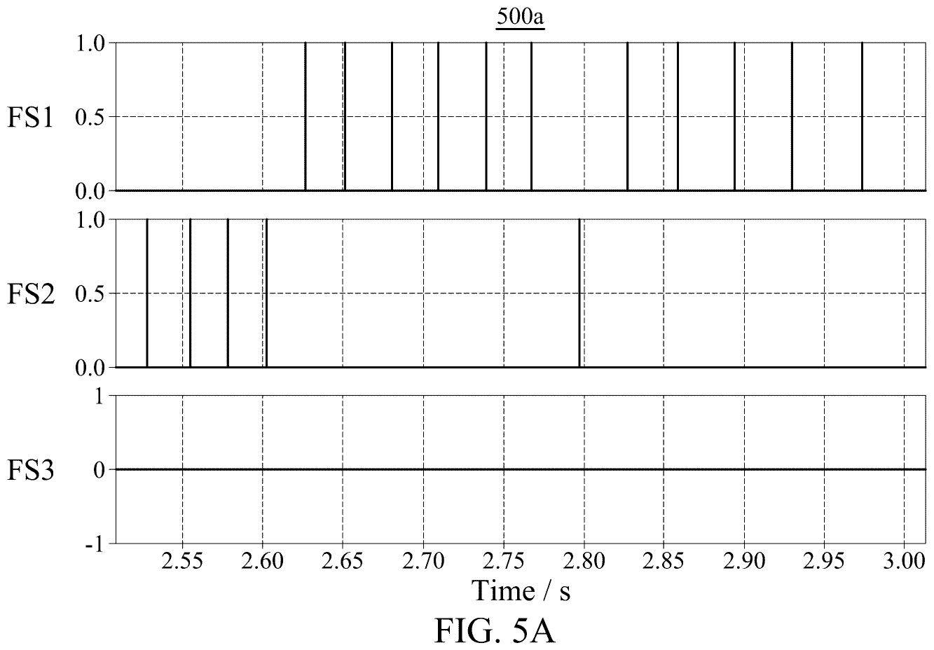

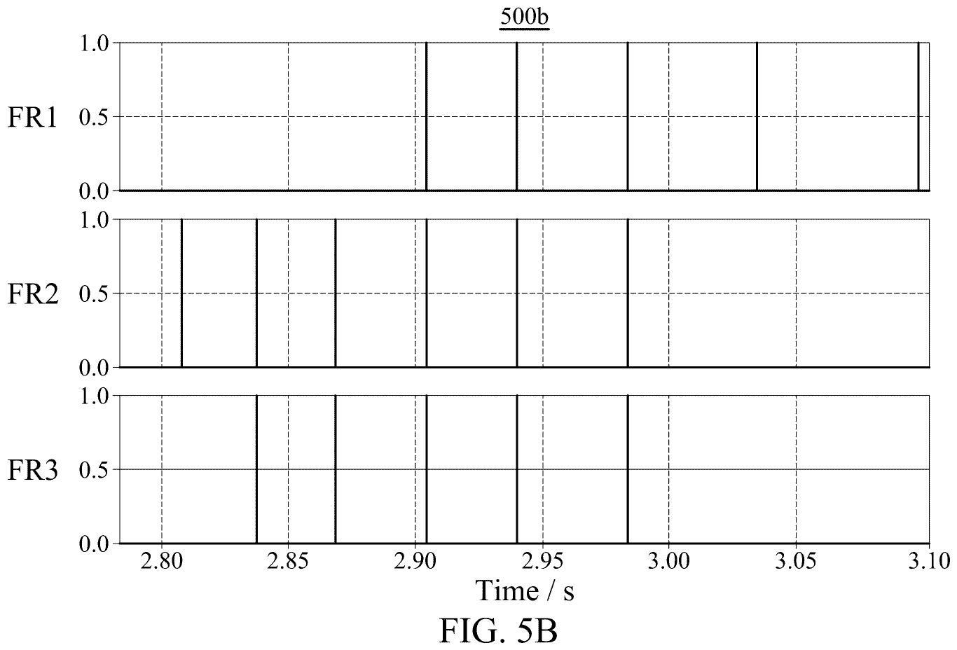

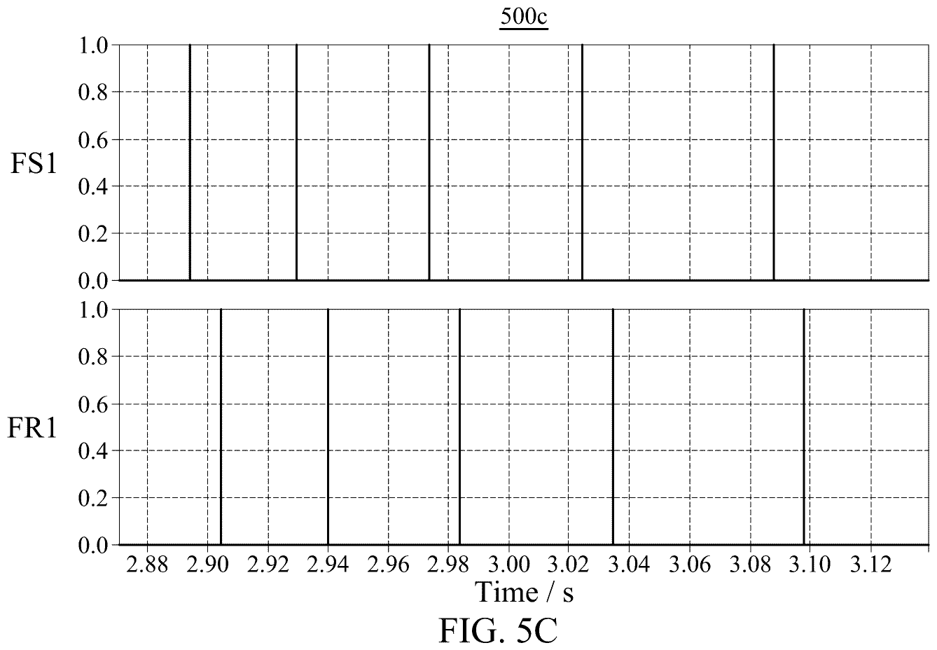

FIG. 5A shows a diagram of the first electrical signal FS indicating a master selection start event in different DGUs according to an embodiment of the present disclosure. Electrical signals FS1, FS2, and FS3 are the first electrical signal FS identified by a first DGU, a second DGU, and a third DGU in the same microgrid, respectively. As shown in FIG. 5A, the electrical signals FS1, FS2, and FS3 will not overlap. Specifically, the first electrical signal FS will be broadcast only when the trigger function f_{tc} is not less than 0, i.e., only when f_{tc}≥0, and all the DGUs that receive the first electrical signal FS will suspend the current droop coefficient regulation process and trigger the next master selection. That is, only one of the DGUs will broadcast the first electrical signal FS.

FIG. 5B shows a diagram of the second electrical signal FR in different DGUs according to an embodiment of the present disclosure. Electrical signals FR1, FR2, and FR3 are the second electrical signal FR identified by the first DGU, the second DGU, and the third DGU in the same microgrid, respectively. Unlike the electrical signals FS1, FS2, and FS3 of FIG. 5A, as shown in FIG. 5B, the electrical signals FS1, FS2, and FS3 may overlap.

The master selection process only needs to count the delay time for one time. However, adjustments to the virtual impedance may take many times to accomplish the desired current sharing performance. Therefore, some of the DGUs may need more adjustments, while some of the DGUs need fewer times of adjustments, causing the second electrical signal FR in each DGU to have different levels (e.g., logical 0 or 1). Additionally, since the frequency of the virtual impedance adjustment is the same in a microgrid, all of the DGUs that need to adjust their virtual impedances will perform each adjustment at the same time, thus causing the second electrical signal FR in different DGUs to overlap.

FIG. 5C shows a diagram of the first electrical signal FS and the second electrical signal FR in the same DGU according to an embodiment of the present disclosure. Take the first DGU mentioned in FIGS. 5A and 5B as an example. Since the droop coefficient regulation process is always performed after the master selection process, the electrical signal FR1 becomes high after the electrical signal FS1 becomes high. That is, the electrical signals FS1 and FR1 will not overlap. Additionally, a delay constant (e.g., Td0_1 and Td0_2) is added to the delay time of a DGU to further ensure a time gap between the master selection process and the droop coefficient regulation process during a single current sharing regulation process. As a result, a sufficient period is provided to prevent the second electrical signal FR becomes high right after the first electrical signal FS becomes high, causing wrong identifications between different electrical signals.

With the aforementioned strategies, only one DGU will broadcast the first electrical signal FS to trigger the master selection process, and only one DGU, i.e., the master DGU, will broadcast the maximum per-unit current (or communication data) to other slave DGUs. Additionally, the next master selection process is triggered only when the trigger function fic meets a first criterion, which further reduces the communication resources required compared with conventional periodic-triggered strategies. That is, the present disclosure provides a method where only one DGU transmits communication data to other DGUs during a single current-sharing control process, while the method further introduces an event-triggered mechanism to reduce the times of performing power regulation before accomplishing the desired current sharing performance.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A distributed generation unit (DGU), comprising:
a meter (116), configured to generate a first per-unit current (Ipu1) of a circuit block (112) based on a first rated power value of the DGU; and
a processor (DSP 114), coupled between a control area network (CAN) bus (130) and the circuit block,
wherein the processor is configured to cause the DGU to:
identify a first electrical signal (FS) at an initial time and perform a master selection process, wherein the master selection process comprises:
determining a first delay time (Td1) based on the first per-unit current and a maximum per-unit current (Imax);
identifying the first per-unit current as the maximum per-unit current when the first delay time has elapsed since the initial time;
broadcasting the maximum per-unit current and a second electrical signal (FR) through the CAN bus after the first per-unit current is identified as the maximum per-unit current; and
performing a droop coefficient regulation process to maintain current state of the DGU after the second electrical signal is broadcast.

2. The DGU as claimed in claim 1, wherein the droop coefficient regulation process comprises:
generating a first initial per-unit current of the DGU via the meter in response to the second electrical signal (FR);
determining a first per-unit current increment based on the first initial per-unit current and a first present per-unit current;
determining a first difference based on the first per-unit current increment and the maximum per-unit current; and
maintaining the current state of the DGU in response to the first difference meeting a first criterion.

3. The DGU as claimed in claim 2, wherein the first criterion is that the first difference is less than zero.

4. The DGU as claimed in claim 2, wherein the first current increment is a difference between the first initial per-unit current and the first present per-unit current, and the first difference is a difference between the first per-unit current increment squared and a multiple of the maximum per-unit current squared.

5. The DGU as claimed in claim 2, wherein the processor is further configured to cause the DGU to:
end the droop coefficient regulation process and start the master selection process in response to the first electrical signal (FS).

6. The DGU as claimed in claim 1, wherein the processor comprises:
a master selection module, configured to generate the maximum per-unit current and the second electrical signal (FR), and configured to determine the first delay time based on the first per-unit current, the maximum per-unit current, and a first preset delay constant in response to the first electrical signal (FS); and
a droop coefficient regulation module, configured to maintain a first virtual impedance of the DGU based on the maximum per-unit current, a first initial per-unit current, and a first present per-unit current in response to the second electrical signal (FR),
wherein the first initial per-unit current is generated in response to the second electrical signal (FR); and
wherein the processor receives the first per-unit current from the meter, transmits the maximum per-unit current to the CAN bus, and outputs a control signal to the circuit block to maintain a first present power value of the DGU.

7. The DGU as claimed in claim 6, wherein the first delay time is generated by adding the first preset delay constant to a multiple of a difference between the first per-unit current and the maximum per-unit current before the first per-unit current is identified as the maximum per-unit current.

8. The DGU as claimed in claim 6, wherein the processor further comprises:
a communication module, configured to broadcast the first electrical signal, the second electrical signal, and the maximum per-unit current through the CAN bus.

9. The DGU as claimed in claim 6, wherein the processor further comprises:
an inner current and voltage regulation module, configured to receive the first per-unit current, the first virtual impedance, and the first rated power value to generate the control signal to maintain the first present power value of the DGU.

10. The DGU as claimed in claim 1, wherein the processor is further configured to cause the DGU to:
broadcast the maximum per-unit current and the second electrical signal (FR) to a parallel DGU through the CAN bus,
wherein the parallel DGU has a second delay time (Td2) that is longer than the first delay time.

11. The DGU as claimed in claim 10, wherein the second delay time is generated based on a second per-unit current of a second rated power value of the parallel DGU, and a preset maximum per-unit current before the first per-unit current is identified as the maximum per-unit current.

12. The DGU as claimed in claim 11, wherein the second delay time is generated by adding a second delay constant to a multiple of a difference between the second per-unit current and the maximum per-unit current before the first per-unit current is identified as the maximum per-unit current.

13. The DGU as claimed in claim 10, wherein after the first electrical signal is identified, the parallel DGU is configured to:
perform the master selection process, which further comprises:
determining a second delay time (Td2) based on the second per-unit current (Ipu2) of the parallel DGU (126) based on a second rated power value (VN2) of the parallel DGU and the maximum per-unit current; and
receiving the second electrical signal (FR) that indicates the master selection end event before the second delay time has elapsed since the initial time and suspending the master selection process; and
performing the droop coefficient regulation process and modifying a second present power value of the parallel DGU after the second electrical signal is broadcast.

14. The DGU as claimed in claim 13, wherein the parallel DGU performs the droop coefficient regulation process in response to the second electrical signal, which comprises:
generating a second initial per-unit current (Îpu2) of the parallel DGU in response to the second electrical signal (FR);
determining a second per-unit current increment based on the second initial per-unit current and a second present per-unit current (Ipu2);
determining a second difference based on the second per-unit current increment and the maximum per-unit current;
modifying the present power value of the parallel DGU in response to the second difference meeting a second criterion.

15. The DGU as claimed in claim 14, wherein the parallel DGU is further configured to:
adjust a second virtual impedance by a change rate proportional to a third difference between the second initial per-unit (Îpu2) current and the maximum per-unit current (Imax) to modify the second present power value of the parallel DGU;
determine a current error between the second present per-unit current (Ipu2) and the maximum per-unit current (Imax); and
suspend the operation of adjusting the second virtual impedance and broadcast the first electrical signal (FS) through the CAN bus in response to the second difference not meeting the second criterion, or in response to the current error being within a preset error range (ER).

16. The DGU as claimed in claim 15, wherein the second criterion is that the second difference is less than zero.

17. The DGU as claimed in claim 14, wherein the second per-unit current increment is a difference between the second initial per-unit current and the second present per-unit current, and the second difference is a difference between the second per-unit current increment squared and a multiple of the maximum per-unit current squared.

18. The DGU as claimed in claim 1, wherein the master selection process further comprises:
generating a third electrical signal with a first level (Fstg=1) to initiate the operation of determining the first delay time in response to the first electrical signal (FS); and
generating the third electrical signal with a second level (Fstg=2) to initiate the droop coefficient regulation process after the second electrical signal (FR) is broadcast.

19. A distributed generation unit (DGU), comprising:
a meter, configured to generate a per-unit current of a circuit block based on a rated power value of the DGU; and
a processor (DSP), coupled between a control area network (CAN) bus and the circuit block,
wherein the processor is configured to cause the DGU to:
identify a first electrical signal at an initial time and perform a master selection process, wherein the master selection process comprises:
determining a delay time based on the per-unit current and a maximum per-unit current;
receiving a second electrical signal through the CAN bus before the delay time has elapsed since the initial time; and
suspending the master selection process in response to the second electrical signal; and
perform a droop coefficient regulation process to modify a present power value of the DGU in response to the second electrical signal.

20. The DGU as claimed in claim 19, wherein the droop coefficient regulation process comprises:
generating an initial per-unit current of the DGU via the meter in response to the second electrical signal (FR);
determining a per-unit current increment based on the initial per-unit current and a present per-unit current;
determining a first difference based on the per-unit current increment and the maximum per-unit current; and
modifying a present power value of the DGU in response to the first difference meeting a first criterion.

21. The DGU as claimed in claim 20, wherein the first criterion is that the first difference is less than zero.

22. The DGU as claimed in claim 20, wherein the droop coefficient regulation process further comprises:
adjusting a virtual impedance by a change rate proportional to a second difference between the initial per-unit current and the maximum per-unit current to modify the present power value of the DGU;
determining a current error between the present per-unit current and the maximum per-unit current; and
suspending the operation of adjusting the virtual impedance and broadcasting the first electrical signal through the CAN bus in response to the first difference not meeting the first criterion, or in response to the current error being within a preset error range.

23. The DGU as claimed in claim 20, wherein the per-unit current increment is a difference between the initial per-unit current and the present per-unit current, and the first difference is a difference between the per-unit current increment squared and a multiple of the maximum per-unit current squared.

24. The DGU as claimed in claim 19, wherein the master selection process further comprises:
generating a third electrical signal with a first level (Fstg=1) to initiate the operation of determining the delay time in response to the first electrical signal (FS); and
receiving the third electrical signal with a second level (Fstg=2) to initiate the droop coefficient regulation process after the second electrical signal (FR) is received.

25. An electrical microgrid system, comprising:
a control area network (CAN) bus;
a plurality of meters, configured to generate a first per-unit current based on a first rated power value of a first DGU, and configured to generate a second per-unit current based on a second rated power of a second DGU; and
a plurality of processors, coupled to the CAN bus and configured to:
identify a first electrical signal that indicates a master selection start event;
determine a first delay time based on the first per-unit current and a maximum per-unit current, and determine a second delay time based on the first per-unit current and the maximum per-unit current;
identify the first per-unit current as the maximum per-unit current in response to the first delay time being less than the second delay time;
broadcast, from the first DGU through the CAN bus, the master per-unit current and a second electrical signal that indicates a master selection end event;
receive, at the second DGU through the CAN bus, the second electrical signal and the maximum per-unit current; and
cause the first DGU to perform a droop coefficient regulation process to maintain a first present power value of the first DGU, and cause the second DGU to perform the droop coefficient regulation process to modify a second present power value after the second electrical signal is broadcast.

26. The electrical microgrid system as claimed in claim 25, wherein the operation of causing the first DGU to perform the droop coefficient regulation process comprises:
generating a first initial per-unit current of the first DGU in response to the second electrical signal (FR);
determining a first per-unit current increment based on the first initial per-unit current and a first present per-unit current;
determining a first difference based on the first per-unit current increment and the maximum per-unit current; and
maintaining a first virtual impedance of the first DGU to maintain the first present power value in response to the first difference meeting a first criterion.

27. The electrical microgrid system as claimed in claim 26, wherein the first criterion is that the first difference is less than zero.

28. The electrical microgrid system as claimed in claim 26, wherein the first per-unit current increment is a difference between the first initial per-unit current and the first present per-unit current, and the first difference is a difference between the first per-unit current increment squared and a multiple of the maximum per-unit current squared.

29. The electrical microgrid system as claimed in claim 25, wherein the operation of causing the second DGU to perform the droop coefficient regulation process comprises:
generating a second initial per-unit current of the second DGU in response to the second electrical signal (FR);
determining a second per-unit current increment based on the second initial per-unit current and a second present per-unit current;
determining a second difference based on the second per-unit current increment and the maximum per-unit current; and
modifying the second present power value of the second DGU in response to the second difference meeting a second criterion.

30. The DGU as claimed in claim 29, wherein the second criterion is that the second difference is less than zero.

31. The DGU as claimed in claim 29, wherein the operation of causing the second DGU to perform the droop coefficient regulation process further comprises:
adjusting a second virtual impedance by a change rate proportional to a third difference between the second initial per-unit current and the maximum per-unit current to modify the second present power value;
determining a current error between the second present per-unit current and the maximum per-unit current; and
suspending the operation of adjusting the second virtual impedance and broadcasting the first electrical signal from the second DGU through the CAN bus in response to the second difference not meeting the second criterion, or in response to the current error being within a preset error range.

32. The DGU as claimed in claim 29, wherein the second per-unit current increment is a difference between the second initial per-unit current and the second present per-unit current, and the second difference is a difference between the second per-unit current increment squared and a multiple of the maximum per-unit current squared.

33. The DGU as claimed in claim 25, wherein the master selection process further comprises:
using the first DGU or the second DGU to generate a third electrical signal with a first level (Fstg=1) that indicates a droop coefficient regulation end event to initiate the operation of determining the first delay time and the second delay time in response to the first electrical signal (FS); and
using the first DGU to generate the third electrical signal with a second level (Fstg=2) to initiate the operation of causing the second DGU to perform the droop coefficient regulation process after the second electrical signal (FR) that indicates the master selection end event is received.

34. A method of current-sharing control in an electrical microgrid system, comprising:
generating a first per-unit current based on a first rated power value of a first distributed generation unit (DGU) and a second per-unit current based on a second rated power value of a second DGU;
identifying a first electrical signal that indicates a master selection start event at an initial time;
determining a first delay time by adding a first delay constant to a multiple of a difference between the first per-unit current and a maximum per-unit current, and determining a second delay time by adding a second delay constant to a multiple of a difference between the second per-unit current and the maximum per-unit current after the first electrical signal is identified;
identifying the first per-unit current as the maximum per-unit current in response to the first delay time elapsing earlier than the second delay time;
broadcasting the maximum per-unit current and a second electrical signal that indicates a master selection end event when the first delay time elapses after the initial time; and
generating a third electrical signal with a first level (Fstg=2) to maintain a first present power value of the first DGU and to modify a second present power value of the second DGU in response to the second electrical signal.

35. The method of current-sharing control in the electrical microgrid system as claimed in claim 34, further comprising:
changing a virtual impedance of the second DGU at a rate proportional to a difference between the maximum per-unit current and an initial per-unit current of the second DGU, wherein the initial per-unit current is generated in response to the second electrical signal being broadcast;
determining a first difference between a present per-unit current of the second DGU and the initial per-unit current;
determining a second difference between the first difference squared and a multiple of the maximum per-unit current squared;
determining a current error between the present per-unit current of the second DGU and the maximum per-unit current;
generating the first electrical signal (FS) to suspend the operation of maintaining the first present power value and modifying the second present power value in response to the current error being within the preset error range, or in response to the second difference meeting a criterion; and
generating the third electrical signal with a second level (Fstg=1) to initiate the operation of determining the first delay time and the second delay time in response to the first electrical signal.

36. The method of current-sharing control in the electrical microgrid system as claimed in claim 35, wherein the criterion is that the second difference is not less than zero.
